(19) United States
(12) Patent Application Publication
(10) Pub. No.: US 2016/0173712 A1
(43) Pub. Date: Jun. 16, 2016

(54) DISTRIBUTION SWITCHING DEVICE

(71) Applicant: KONICA MINOLTA, INC., Tokyo (JP)

(72) Inventor: Masato FUJII, Nagaokakyo-shi (JP)

(73) Assignee: KONICA MINOLTA, INC., Tokyo (JP)

(21) Appl. No.: 14/962,376

(22) Filed: Dec. 8, 2015

(30) Foreign Application Priority Data
Dec. 16, 2014 (JP) 2014-254117

(51) Int. Cl. H04N 1/00; H04L 12/28; G06F 3/12; H04L 29/08

(52) U.S. Cl. CPC H04N 1/00323; H04L 67/10; H04L 12/2801; H04L 12/2854; H04N 1/00244; G06F 3/1205; G06F 3/1263; G06F 3/1289; H04N 2201/0094

(57) ABSTRACT

A distribution switching device includes: a receiving unit that receives distributed data being distributed through cloud to a single distribution destination specified by a cloud server; and a determination unit that determines which of a plurality of image forming apparatuses, each configured to print out the distributed data, is caused to print out the distributed data, wherein the distribution switching device is connected to the cloud server via a WAN and the plurality of image forming apparatuses via a LAN only.

The entire disclosure of Japanese Patent Application No. 2014-254117 filed on Dec. 16, 2014 including description, claims, drawings, and abstract are incorporated herein by reference in its entirety.

### BACKGROUND OF THE INVENTION

1. Field of the Invention

The present invention relates to a distribution switching device, particularly to a technique of switching a receiver of a cloud distribution service at a distribution destination where a distribution service is received from a cloud server.

2. Description of the Related Art

In recent years, a cloud service has come to be utilized to broadcast news, where the news distributed from a key station through the cloud is received by using a multi-function peripheral (MFP) installed in a local station at a distribution destination and is then printed out.

A method of operating the MFP serving as a receiver varies depending on the local station, where the news is less likely received by a single MFP continuously but is received while switching the MFPs for the purpose of maintenance or the like in some cases or, in other cases, periodically switching the MFPs installed on different floors according to different day and night work patterns.

In response to such needs, for example, there is proposed a technique in which an MOP being a distribution destination of document data sets a time slot available for receiving the data against an information processing apparatus being a distribution source so that the distribution of the document data is controlled (refer to JP 2013-021532 A, for example). According to this proposal, a time slot available for reception that is different for each of a plurality of MFPs can be set to be able to switch the MFPs being the distribution destination.

In the cloud distribution service, however, it is undesirable in terms of administration of a cloud system that a distribution operation of a cloud server is controlled by the MFP on the receiver side, and yet it takes time and effort for an administrator of the cloud system to set the distribution operation of the cloud server while considering a situation specific to each distribution destination, which is troublesome for the administrator and may cause erroneous setting especially when a number of distribution destinations are involved.

### SUMMARY OF THE INVENTION

The present invention has been made in consideration of the aforementioned problems, and an object thereof is to provide a distribution switching device which can switch a receiver flexibly according to the situation of the distribution destination in the cloud distribution service.

To achieve the abovementioned object, according to an aspect, a distribution switching device reflecting one aspect of the present invention comprises: a receiving unit that receives distributed data being distributed through cloud to a single distribution destination specified by a cloud server; and a determination unit that determines which of a plurality of image forming apparatuses, each configured to print out the distributed data, is caused to print out the distributed data, wherein the distribution switching device is connected to the cloud server via a wide area network (WAN) and the plurality of image forming apparatuses via a local area network (LAN) only.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a diagram illustrating a schematic configuration of a cloud distribution system;

FIG. 2 is a block diagram illustrating a functional configuration of a distribution switching device;

FIG. 3 is a table illustrating a switching condition stored in a distribution destination management;

FIG. 4 is a flowchart illustrating an operation of the distribution switching device;

FIG. 5 is a block diagram illustrating a functional configuration of a distribution switching device;

FIG. 6 is a flowchart illustrating an operation of the distribution switching device;

FIG. 7 is a flowchart illustrating distribution destination diagnostic processing;

FIG. 8 is a block diagram illustrating a functional configuration of a distribution switching device;

FIG. 9 is a flowchart illustrating an operation of the distribution switching device; and

FIG. 10 is a flowchart, illustrating an operation of the distribution switching device.

### DESCRIPTION OF THE PREFERRED EMBODIMENTS

Hereinafter, an embodiment of a distribution switching device according to the present invention will be described, with reference to the drawings while giving a cloud distribution system as an example. However, the scope of the invention is not limited to the illustrated examples.

### [1] First Embodiment

A first embodiment of the present invention will be described first.

### (1-1) Configuration of Cloud Distribution System

First, a schematic configuration of a cloud distribution system according to the present embodiment will be described.

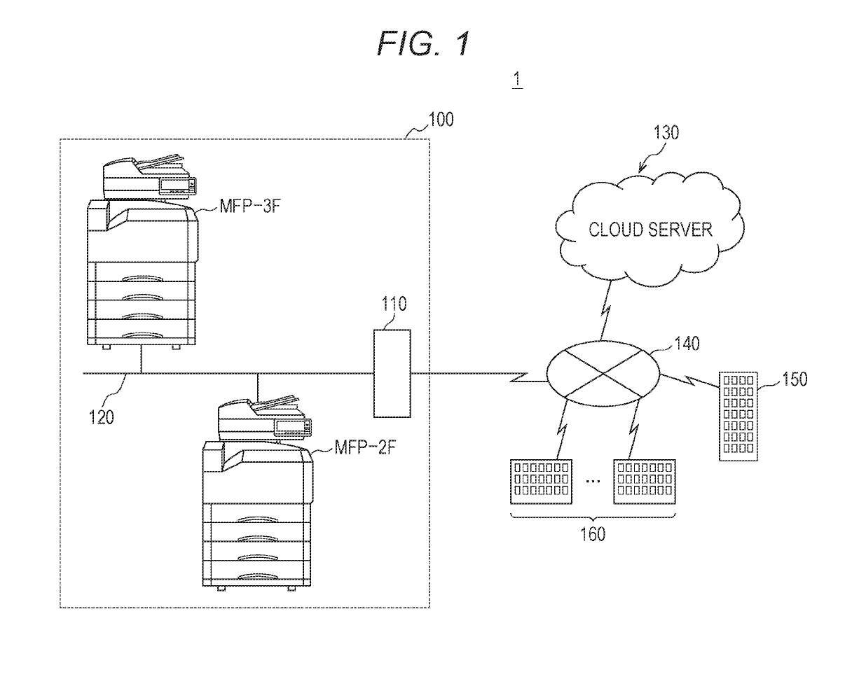

As illustrated in FIG. 1, a cloud distribution system 1 is configured such that a key station 150, local stations 100 and 160, and a cloud server 130 are connected through an Internet 140 where news is distributed from the key station 150 to the local stations 100 and 160 by the cloud server 130. In particular, a LAN 120 in the local station 100 is connected to the Internet 140 through a distribution switching device 110 as well as to an MFP-2F and an MFP-3F. The MFP-2F and MFP-3F in the present embodiment are installed on different floors (second and third floors, respectively) of the local station 100.

### (1-2) Distribution Switching Device 110

The distribution switching device 110 will now be described.

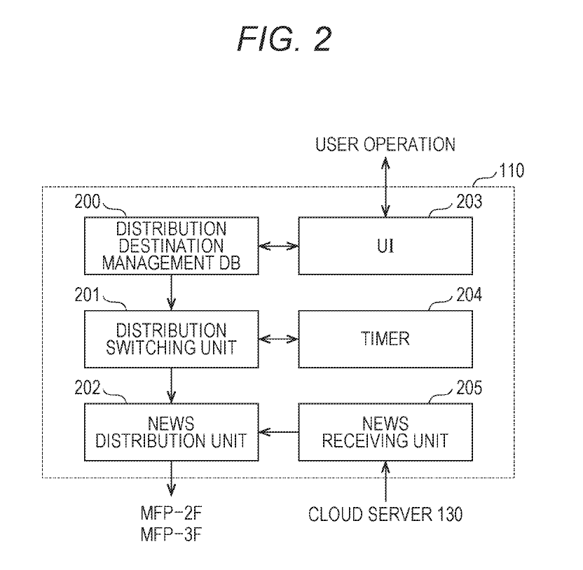

As illustrated in FIG. 2, the distribution switching device 110 is configured such that news distributed by the cloud server 130 through the Internet 140 is received by a news receiving unit 205 and then distributed by a news distribution unit 202 to either one of the MFP-2F and the MFP-3F.

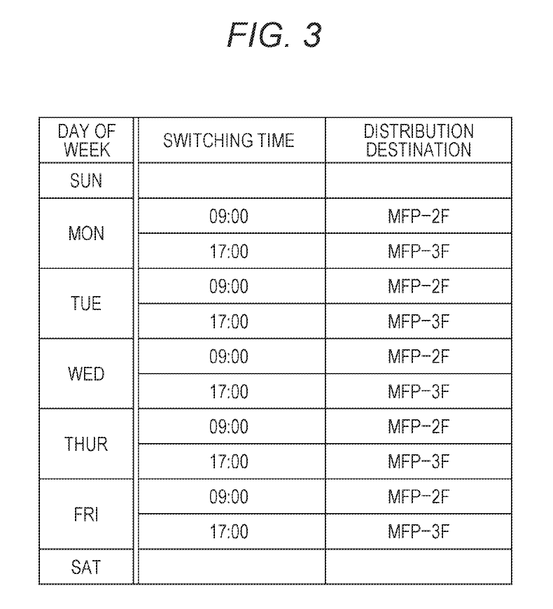

A distribution destination management DB (DataBase) 200 stores a switching condition under which a distribution destination of the news is switched. The distribution destination management DB 200 stores the switching condition for one week as illustrated in FIG. 3, for example. The distribution destination management DB 200 illustrated in FIG. 3 specifies days of a week under a day-of-week column and a time of switching the distribution destination for each day of the week under a switching time column. A distribution destination selected after switching is specified under a distribution destination column.

FIG. 3 illustrates an example where the distribution destination is not switched on Sunday and Saturday. On weekdays (from Monday to Friday), the destination is switched to the MFP-2F at nine o' clock in the morning so that news is distributed to the MFP-2F until five o' clock in the evening (17:00). The distribution destination is then switched to the MFP-3F at five o' clock in the evening so that the MFP-3F receives news until nine o' clock the next morning.

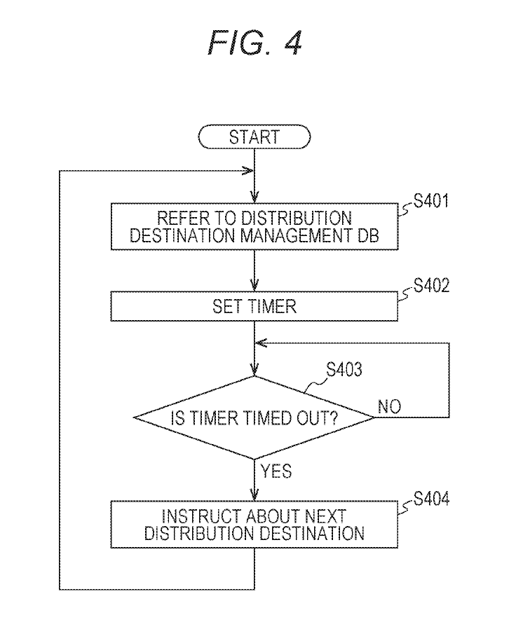

As illustrated in FIG. 4, a distribution switching unit 201 first refers to the distribution destination management DB 200 to acquire next switching time and distribution destination (S401), and sets a timer 204 to the next switching time (S402). When one knows by a timeout of the timer 204 that it is now the next switching time (S403), the distribution switching unit 201 instructs the news distribution unit 202 about the next distribution destination (S404).

Then, the distribution switching unit 201 refers to the distribution destination management DB 200 again (S401) and acquires next switching time and distribution destination. The news distribution unit 202 stores the distribution destination instructed and distributes news from then on to the distribution destination. The distribution destination of the news is switched by repeating the aforementioned processing.

The distribution switching device 110 further includes a user interface (UI) 203. The user interface 203 is used when an administrator of the distribution switching device 110 sets the distribution destination management DB or checks the setting thereof. As a result, the local station 100 can perform setting to switch the distribution destination on its own without causing an administrator of the cloud server 130 any trouble. The distribution destination can thus be switched flexibly according to circumstances of the local station being the distribution destination of the cloud distribution service.

### [2] Second Embodiment

A second embodiment of the present invention will now be described.

A distribution switching device of the second embodiment not only includes a configuration similar to that of the distribution switching device 110 of the first embodiment but is also characterized to switch a distribution destination by checking an operating state of the distribution destination. The following description will focus on this characteristic. Note that a reference numeral identical to that in the preceding embodiment is assigned to a component corresponding to that in the preceding embodiment.

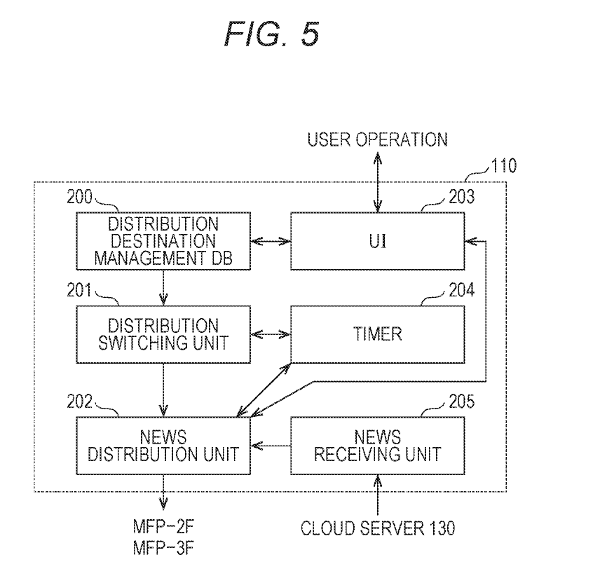

A news distribution unit 202 of the distribution switching device 110 according to the present embodiment operates in conjunction with a user interface 203 and a timer 204 as illustrated in FIG. 5.

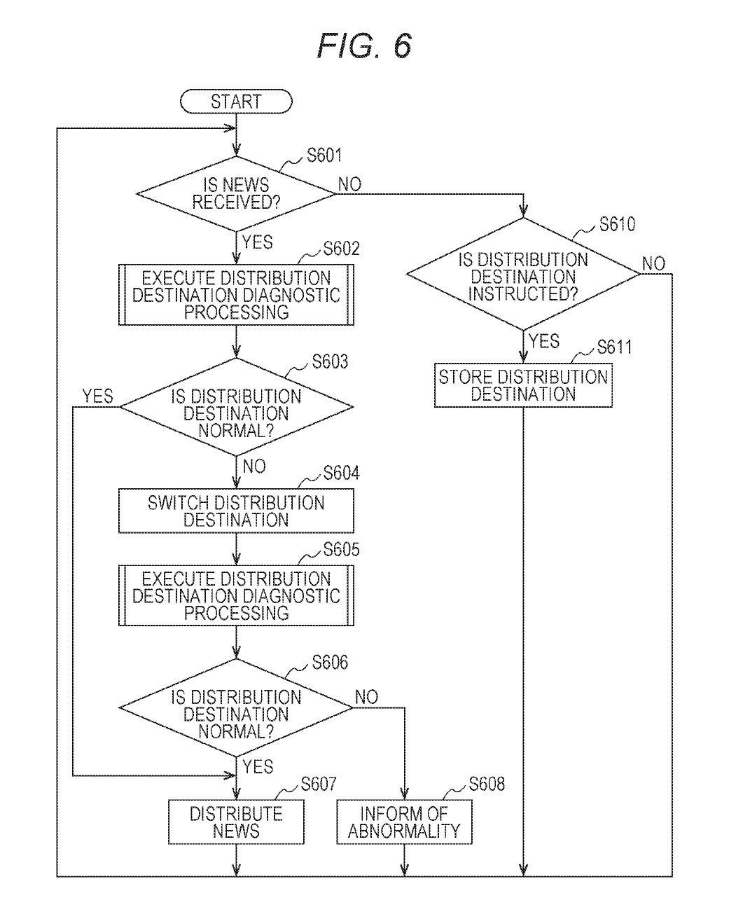

Specifically, as illustrated in FIG. 6, the news distribution unit accepts news from a news receiving unit 205 (S601) and, before distributing the news, executes distribution destination diagnostic processing that diagnoses whether or not a distribution destination is normal (S602). The news distribution unit 202 distributes the news to the distribution destination (S607) when determining as a result of the distribution destination diagnostic processing that the distribution destination is normal (S603: YES).

When determining that the distribution destination is not normal (S603: NO), the news distribution unit switches a distribution destination (S604) and executes distribution destination diagnostic processing on the distribution destination selected after switching (S605). The news distribution unit 202 distributes the news to the distribution destination selected after switching (S607) when determining as a result of the diagnostic processing that the distribution destination selected after switching is normal (S606: YES).

As a result, the distribution destination selected after switching prints out the news on behalf of the distribution destination selected before switching. Note that in this case, the distribution switching device 110 may prepare an error report stating that the distribution destination before switching cannot print out the news and may cause the distribution destination selected after switching to print out the error report.

When determining that the distribution destination selected after switching is not normal, either (S606: NO), the news distribution unit 202 informs of an abnormality through the user interface 203 (S608). An alarm sound may be output or an alarm lamp may be turned on in order to inform an administrator of the distribution switching device 110 about the abnormality. Moreover, the distribution switching device 110 may return an error report, stating there is no distribution destination that can perform printing out, to a cloud server 130.

As with the first embodiment, the news distribution unit 202 receives an instruction about a distribution destination from a distribution switching unit 201 (S610: YES) and stores the distribution destination (S611). Accordingly, when the distribution destination has no abnormality, news is distributed to the distribution destination set in a distribution destination management DB 200 as with the first embodiment.

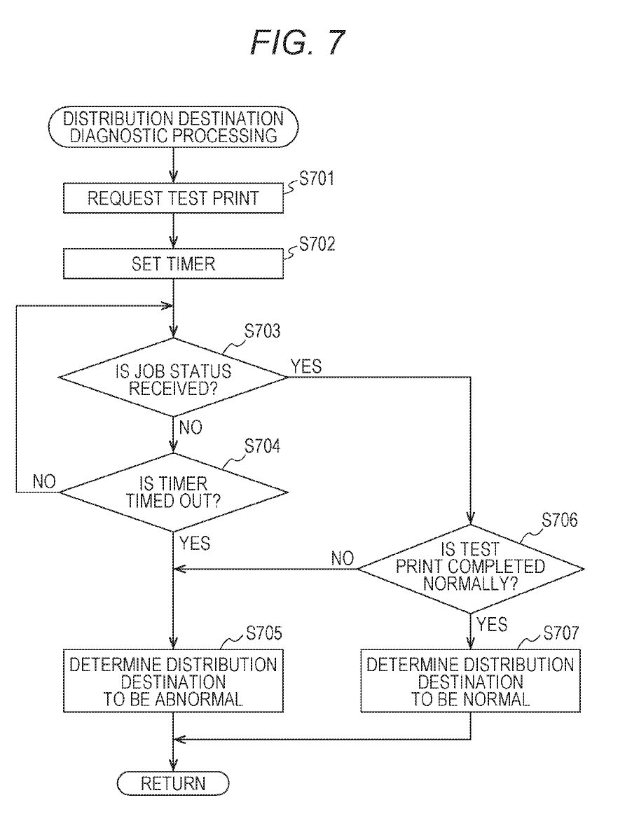

The distribution destination diagnostic processing is executed as follows, for example. As illustrated in FIG. 7, the news distribution unit first requests a distribution destination to perform test print (S701) and sets the timer 204 (S702). A job status of the test print is then received from the distribution destination (S703: YES) and, when the test print is completed normally (S706: YES), the distribution destination is determined to be able to print out news (distributed data). The distribution destination is thus determined to be normal (S707), whereby the processing returns to an upper routine.

When the test print is not completed normally due to some ca use such as being out of paper or toner (S706: NO), the distribution destination is determined to be unable to print out the news (distributed data). The distribution destination is thus determined to be abnormal (S705), and then the processing returns to the upper routine. The distribution destination is also determined to be abnormal (S705) when a timeout occurs (S704: YES) with no job status received (S703: NO), and then the processing returns to the upper routine.

Note that the distribution destination diagnostic processing may be adapted to not only acquire information on the state of the distribution destination by the test print but also acquire a state of the device of the distribution destination by using an SNMP (Simple Network Management Protocol) or an OpenAPI and determine whether or not the device is normal. The normality of the distribution destination may also be determined while checking presence/absence of a response from the distribution destination (availability for mutual communication) by using Ping or the like of the SNMP.

Moreover, the informing of the abnormality (S608) may be performed in the aforementioned manner, or performed by causing the distribution destination determined to be normal to print out a document informing of the abnormality of another distribution destination or by automatically sending an e-mail informing of the abnormality to the administrator of the distribution switching device 110.

### [3] Third Embodiment

A third embodiment of the present invention will now be described.

A distribution switching device of the third embodiment includes a configuration similar to that of the distribution switching device 110 of the first embodiment for the most part, but has a distribution destination switching condition different from that of the first embodiment. The following description will focus on this difference.

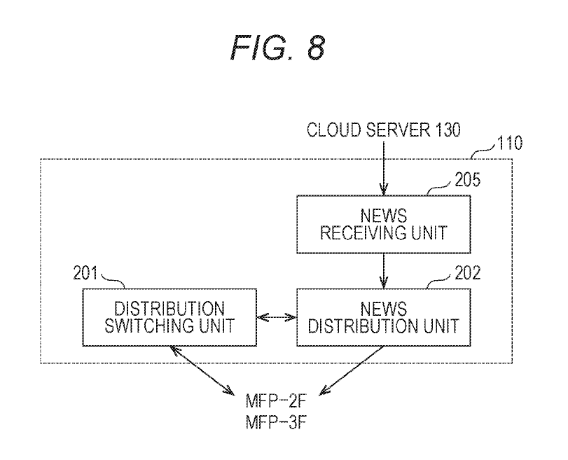

A distribution switching device 110 according to the present embodiment includes a distribution switching unit 201, a news distribution unit 202 and a news receiving unit 205 as illustrated in FIG. 8, where news distributed by a cloud server 130 is received by the news receiving unit 205 and distributed to an MFP-2F or MFP-3F by the news distribution unit 202.

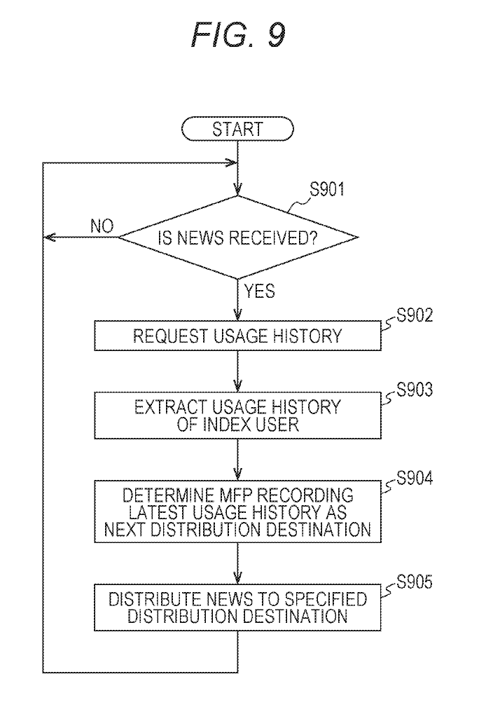

A distribution destination is selected as follows. That is, as illustrated in FIG. 9, news is received by the news receiving unit 205 of the distribution switching device 110 (S901: YES), which then acquires a usage history from each of the MFP-2F and MFP-3F being the distribution destinations (S902) prior to distributing the news.

The usage history of a specific user (hereinafter referred to as an “index user”) is extracted (S903). Moreover, the latest usage history among the extracted usage history is extracted, so that the news is distributed (S905) to an MFP recording the latest usage history as a next distribution destination (S904).

Accordingly, when the index user corresponds to a person or department in charge of handling the distributed news, for example, the news is distributed to an MFP installed near the index user on the assumption that the MFP is used by the index user at the time the news is distributed, whereby the news can be promptly delivered to the index user.

Note that instead of using the latest usage history, the latest number of outputs (number of jobs=rate of operation) per unit time may be counted to select an MFP with the larger number of outputs (higher rate of operation) as the distribution destination. This can improve convenience of a user since the news is distributed to the frequently used MFP and printed out.

Since it is less likely that the rate of operation of each distribution destination changes greatly during a short period of time, the rate of operation may be acquired periodically. This allows one to select the distribution destination without repeatedly acquiring the rate of operation even when the news is repeatedly distributed in a short period of time, whereby processing load and network load required to acquire the rate of operation can be reduced.

Furthermore, when the MFP-2F and MFP-3F are connected to different network segments, the number of PCs (Personal Computers) running in each network segment may be detected to select an MFP that is connected to the network segment with the larger number of PCs as the distribution destination. This as well allows the news to be distributed to the frequently used MFP and printed out.

### [4] Fourth Embodiment

A fourth embodiment of the present invention will now be described.

A distribution switching device of the fourth embodiment includes a configuration similar to that of the distribution switching device 110 of the second embodiment for the most part, but is different from the second embodiment in that a distribution request and a distribution path generation request are received to determine propriety thereof before receiving news from a cloud server. The following description will focus on this difference.

A distribution switching device 110 of the present embodiment includes a configuration similar to that of the distribution switching device 110 of the second embodiment (FIG. 5) but also serves as a tunnel server. News distributed through cloud is distributed to an MFP-2F or MFP-3F via a tunnel generated by the distribution switching device 110.

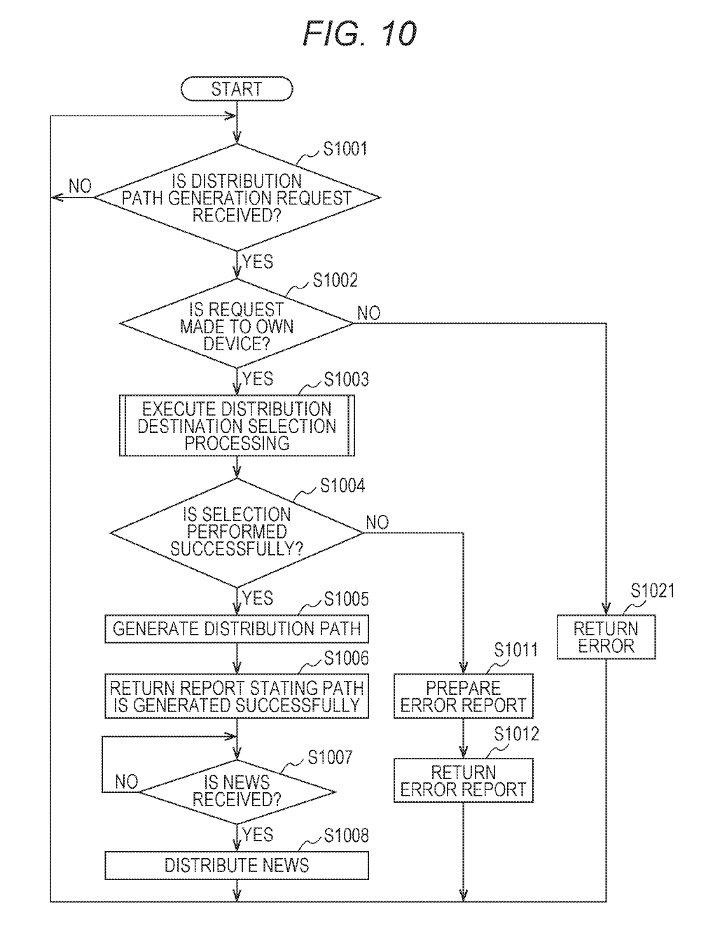

As illustrated in FIG. 10, when the distribution switching device 110 receives the distribution request and the distribution path generation request from a cloud server 130 (S1001), a news receiving unit 205 of the distribution switching device 110 checks a destination of request of the request. The destination of request is indicated in a header of the request, for example, so that the news receiving unit checks whether the destination of request indicated corresponds with the device itself.

When the destination of request does not correspond with the device itself (S1002: NO), the distribution switching device 110 returns to the cloud server 130 an error stating that the destination of request is wrong (S1021) and proceeds to step S1001.

The distribution switching device executes distribution destination selection processing (S1003) when the destination of request corresponds with the device itself (S1002: YES). The distribution destination selection processing corresponds to the processing performed in steps S602 to S606 of the second embodiment, where selection is determined to be successful when a normal distribution destination is available or determined to be unsuccessful when a normal distribution destination is not available.

When the selection is determined to be unsuccessful (S1004: NO), the distribution switching device 110 prepares an error report stating that a distribution path is not generated due to a malfunction in the MFP-2F and MFP-3F (S1011), returns the error report to the cloud server 130 (S1012), and proceeds to step S1001.

When the selection is determined to be successful (S1004: YES), the distribution switching device 110 generates the distribution path (S1005), returns an error stating that the distribution path is successfully generated to the cloud server 130 (S1006), and waits for the news to be distributed. Upon receiving the news from the cloud server 130 (S1007: YES), the distribution switching device 110 distributes the news to the selected distribution destination (S1008) and proceeds to step S1001.

Note that the cloud server 130 may make the distribution request and distribution path generation request according to an XMPP (eXtensible Messaging and Presence Protocol), while the distribution switching device 110 may determine propriety of the destination of request of the cloud server 130 by checking a tenant ID of the distribution destination pertaining to the request (a connection destination of the distribution path). The distribution switching device 110 may also generate a distribution path for HTTP (HyperText Transfer Protocol) tunneling.

### [5] Variation

While the present invention has been described on the basis of the embodiments, the present invention is certainly not to be limited to the aforementioned embodiments but can implement the following variations as well.

(1) While the fourth embodiment has described the example of using the HTTP tunneling, the present invention is certainly not to be limited to such example but may use another tunneling technique instead of the HTTP tunneling to obtain the same effect. It is however desirable to use a tunneling technique that can dynamically switch a path due to the need of switching the distribution destination.

(2) While the aforementioned embodiments have described the example where the MFP is used as the image forming apparatus being the distribution destination of the news, the present invention is certainly not to be limited to such example but may use a printer, a copier equipped with a scanner, or a facsimile equipped with a communication function instead of the MFP. The printout may be in black and white or in color.

(3) While the aforementioned embodiments have described the cloud distribution system distributing the news as the example, the present invention is certainly not to be limited to such example but the same effect can be obtained by applying the present invention when distributing data other than the news as well.

(4) While the aforementioned embodiments have described the example where the distribution switching device 110 is connected to the Internet 140, the present invention is certainly not to be limited to such example but may be adapted as follows. That is, the distribution switching device 110 may be connected to an Internet connection device through the LAN 120 and receive news through the Internet connection device.

The distribution switching device 110 may also receive news through a WAN other than the Internet such as a circuit switched network. The distribution switching device 110 may be connected to the WAN through a private branch exchange (PBX) as well. The present invention can be applied to obtain the effect thereof regardless of the network configuration.

The distribution switching device according to the preset invention is effective when used as a device that switches a receiver of the cloud distribution service at the distribution destination where a distribution service is received from the cloud server.

According to an embodiment of the present invention, the distribution switching device is connected via the LAN to the image forming apparatus that prints out the distributed data being distributed through cloud to the single distribution destination specified by the cloud server, whereby the distribution switching device is installed at the distribution destination of the cloud distribution service to be able to switch the distribution destination flexibly according to the situation of the distribution destination.

Although the present invention has been described and illustrated in detail, it is clearly understood that the same is by way of illustrated and example only and is not to be taken byway of limitation, the scope of the present invention being interpreted by terms of the appended claims.

What is claimed is:

1. A distribution switching device comprising:
a receiving unit that receives distributed data being distributed through cloud to a single distribution destination specified by a cloud server; and
a determination unit that determines which of a plurality of image forming apparatuses, each configured to print out the distributed data, is caused to print out the distributed data, wherein
the distribution switching device is connected to the cloud server via a WAN and the plurality of image forming apparatuses via a LAN only.

2. The distribution switching device according to claim 1, further comprising a storage unit that stores specification of an image forming apparatus that is to perform printing out for each time slot, wherein
the determination unit determines the image forming apparatus that is to perform printing out according to the specification stored in the storage unit.

3. The distribution switching device according to claim 2, further comprising:
an output feasibility determination unit that determines whether or not an image forming apparatus specified in a time slot, in which the distributed data is distributed through cloud, can print out the distributed data; and
a prohibition unit that prohibits transferring of the distributed data to the image forming apparatus when the image forming apparatus is determined to be unable to print out the distributed data.

4. The distribution switching device according to claim 3, further comprising a take-over determination unit that determines whether or not there exists an image forming apparatus which can take over the printing out of the distributed data, the image forming apparatus being other than the image forming apparatus specified in the time slot in which the distributed data is distributed through cloud and determined to be unable to perform the printing out by the output feasibility determination unit, wherein
when determination of the take-over determination unit is affirmative, the determination unit determines the image forming apparatus capable of taking over the printing out to be an image forming apparatus that prints out the distributed data.

5. The distribution switching device according to claim 4, further comprising a notification unit that causes the image forming apparatus capable of taking over the printing out to print out a notification stating that the image forming apparatus specified as a distribution destination in the time slot in which the distributed data is distributed through cloud cannot perform the printing out.

6. The distribution switching device according to claim 4, wherein an error report is returned to the cloud server when there is no image forming apparatus that can take over the printing out.

7. The distribution switching device according to claim 3, further comprising an informing unit that informs an administrator of the distribution switching device of a notification that determination made by the output feasibility determination unit is negative.

8. The distribution switching device according to claim 3, wherein the output feasibility determination unit determines that the image forming apparatus specified in the time slot in which the distributed data is distributed through cloud cannot perform printing out when unable to perform mutual communication with the image forming apparatus.

9. The distribution switching device according to claim 3, further comprising a state information acquisition unit that acquires state information of the image forming apparatus specified in the time slot in which the distributed data is distributed through cloud, wherein
the output feasibility determination unit determines feasibility of the printing out according to the state information.

10. The distribution switching device according to claim 9, wherein the state information acquisition unit requests the image forming apparatus to perform test print and acquires the state information according to a job status returned in response to the request.

11. The distribution switching device according to claim 2, wherein the storage unit stores in a table the specification of the image forming apparatus that is to perform printing out in each time slot.

12. The distribution switching device according to claim 1, further comprising a rate-of-operation acquisition unit that acquires a rate of operation of each image forming apparatus, wherein
the determination unit determines to cause an image forming apparatus with the highest rate of operation to perform printing out.

13. The distribution switching device according to claim 12, wherein the rate-of-operation acquisition unit acquires a higher value of the rate of operation as the image forming apparatus is used later by a predetermined user.

14. The distribution switching device according to claim 12, wherein the rate-of-operation acquisition unit periodically acquires the number of jobs executed by each image forming apparatus as the rate of operation.

15. The distribution switching device according to claim 12, wherein the rate-of-operation acquisition unit acquires as the rate of operation the number of terminal devices belonging to the same network segment as the image forming apparatus and started up when the distributed data is distributed through cloud.

16. The distribution switching device according to claim 1, further comprising:
an acceptance unit that accepts a connection request to connect to an image forming apparatus being a transfer destination from a cloud prior to distributing the distributed data through cloud;
a checking unit that checks propriety of the connection request; and
an establishment unit that establishes a communication path used to distribute the distributed data to the image forming apparatus from the cloud when the propriety of the connection request is checked.

17. The distribution switching device according to claim 16, further comprising a connection destination storage unit that stores in advance a connection destination pertaining to the connection request, wherein
the checking unit checks the propriety on the basis of whether or not specification of a connection destination pertaining to the connection request corresponds with the connection destination stored in the connection destination storage unit.

18. A switching method performed by a distribution switching device connected to a cloud server via a WAN and a plurality of image forming apparatuses via a LAN only, the method comprising the steps of:
receiving distributed data that is distributed through cloud to a single distribution destination specified by the cloud server; and
determining which of the plurality of image forming apparatuses, each configured to print out the distributed data, is caused to print out the distributed data.

19. A non-transitory recording medium storing a computer readable program which is executed on a computer of a distribution switching device connected to a cloud server via a WAN and a plurality of image forming apparatuses via a LAN only, and which causes the computer to execute the steps of:
receiving distributed data that is distributed through cloud to a single distribution destination specified by the cloud server; and
determining which of the plurality of image forming apparatuses, each configured to print out the distributed data, is caused to print out the distributed data.
